(19) United States
(12) Patent Application Publication
(10) Pub. No.: US 2024/0291512 A1
(43) Pub. Date: Aug. 29, 2024

(54) Remote Monitoring of Assets

(71) Applicant: Machinery Monitoring Systems, LLC, Knoxville, TN (US)

(72) Inventor: John Biondolillo, Lockport, NY (US)

(21) Appl. No.: 18/399,243

(22) Filed: Dec. 28, 2023

Related U.S. Application Data
(60) Provisional application No. 63/479,458, filed on Jan. 11, 2023.

(51) Int. Cl. H04B 1/40; G01P 15/18; H02J 50/00; H02J 50/20

(52) U.S. Cl. CPC H04B 1/40; G01P 15/18; H02J 50/001; H02J 50/20

(57) ABSTRACT

Methods and systems for monitoring assets in an environment are described. The systems include sensor packages that include a sensor, such as an accelerometer. The sensor packages are configured to harvest radio frequency (RF) energy and use the harvested energy to power the package, the sensor, and the transmission of data between the package and a remote antenna.

### CROSS REFERENCE TO RELATED APPLICATIONS

This is a non-provisional of U.S. Provisional Patent Application Ser. No. 63/479,458, filed Jan. 11, 2023, to which priority is claimed, and which is incorporated herein by reference.

### FIELD OF THE INVENTION

This application relates to systems and methods for monitoring assets in an environment. More specifically, sensors harvest radio frequency (RF) energy from the atmosphere and use the energy to power sensor elements and/or the transmission of data from the sensors.

### INTRODUCTION

Monitoring the maintenance, performance, and location of assets is an important aspect of maintaining operations in a variety of environments. One example of an environment is a plant, such as a gas processing plant, which involves many pieces of equipment (“assets”). Equipment is often categorized as being “high value assets” or “balance of plant (BoP) assets.” High value assets typically include large compressors, critical pumps, etc., that may cost in the millions of dollars or more and that typically include monitoring systems. BoP assets include other assets that support the operations of the plant. BoP assets, while important to the operation of the plant, may not justify the time and expense of installing a very expensive monitoring system. Much of this equipment, such as pumps, compressors, fans, motors, etc., relies on rotating or reciprocating machines or components. This equipment is prone to wear and failure and can halt operations within the plant when such failure occurs. Monitoring the operation and state of such assets is therefore vital to preventing unplanned shutdowns.

Another example of an environment is a healthcare facility, such as a hospital. Such facilities rely on a variety of assets, such as diagnostic and/or treating equipment, support equipment (e.g., IV infusion pumps), and emergency response assets (e.g., “crash carts”). Monitoring the location and state of such assets is understandably critical.

A variety of sensors exist for monitoring the state and health of various types of equipment/assets. For example, accelerometers are used to monitor assets that involve rotating and/or reciprocating components and can also be used to monitor assets that might be jarred or impacted. Other types of sensors, such as flow sensors, temperature sensors, pressure sensors, and the like may be used to monitor the state and operation of various types of equipment. In distributed environments, like the ones mentioned above (and many others), hard wiring such sensors to a central data processing center becomes problematic. Moreover, hard wiring may not be possible for assets that are moveable. Accordingly, wireless solutions for monitoring assets in a distributed environment are needed.

### SUMMARY

Disclosed herein is a monitoring system for monitoring assets in an environment, the system comprising: at least one sensor package configured to couple to an asset, each of the sensor packages comprising: an antenna configured to receive radio frequency (RF) energy, rectifier circuitry configured to convert a portion of the RF energy to electrical energy, at least one sensor powered by the electrical energy and configured to sense a condition of the asset, and transmission circuitry powered by the electrical energy and configured to cause the antenna to transmit one or more signals comprising data indicative of the sensed condition. According to some embodiments, the sensor package further comprises a power storage and circuitry configured to charge the power storage using the electrical energy. According to some embodiments, the power storage is a battery, a supercapacitor, or a capacitor. According to some embodiments, the asset is a pump, engine, motor, compressor, or fan. According to some embodiments, the sensor comprises an accelerometer, a temperature sensor, a flow meter, ultrasonic, or a pressure sensor. According to some embodiments, the condition is vibration, acceleration, temperature, flow rate or pressure. According to some embodiments, the sensor comprises an accelerometer configured to sense vibration of a portion of the asset to determine vibration data. According to some embodiments, the sensor package further comprises control circuitry configured to process the vibration data. According to some embodiments, the control circuitry is further configured to use the vibration data to determine an indicium of health of the asset. According to some embodiments, the processing comprises performing a fast Fourier transform (FFT) of the vibration data. According to some embodiments, the transmission circuitry is configured to associate an identifier indicative of the sensor with the transmitted one or more signals. According to some embodiments, the RF energy has a frequency of 902 to 928 MHz. According to some embodiments, the RF energy has a frequency 2.4-2.5 GHz. According to some embodiments, the RF energy is ambient RF energy generated by one or more motors and/or generators. According to some embodiments, the system further comprises one or more remote antennas configured to broadcast the RF energy throughout at least a portion of the environment. According to some embodiments, the one or more transponders are configured to receive the one or more signals. According to some embodiments, the system further comprises a processor configured to receive the one or more signals from the remote antenna and to use the signals to determine an indicium of health of the asset. According to some embodiments, the condition is vibration, proximity, temperature, pressure, flow, and or location.

In some embodiments of the system, some memory may be omitted and may only rely on the memory contained within the antenna IC. In such embodiments, the controller may be used to write Data to the antenna IC registers. That controller would then regulate the population of Data on the antenna IC as it is updated (transmitted/ready for transmission), acting as a Data flow controller. In some embodiments, smaller power storage device(s) may be incorporated as it would only energize the controller and not assist in the Data transmission. The antenna IC would solely be energized by the interrogating antenna (passive architecture). According to some embodiments, such as a passive transmission design, much of the circuitry may be scaled down or omitted, including the charge capacitors, boost converter, storage capacitor(s) and/battery, memory, etc., resulting in a lower cost device.

### BRIEF DESCRIPTION OF THE DRAWINGS

FIG. 1A shows an RFID tag and FIG. 1B shows a high-level schematic of components of an RFID tag.

FIG. 2 shows a logical schematic of an embodiment of a sensor package.

FIG. 3 shows an embodiment of rectifier circuitry and charging circuitry.

FIG. 4 shows an embodiment of a system of sensor tags deployed in a plant environment.

FIG. 5 shows an embodiment of sensor tags deployed on a centrifugal pump.

FIG. 6A shows accelerometer data and FIG. 6B shows accelerometer data processed using FFT.

### DETAILED DESCRIPTION

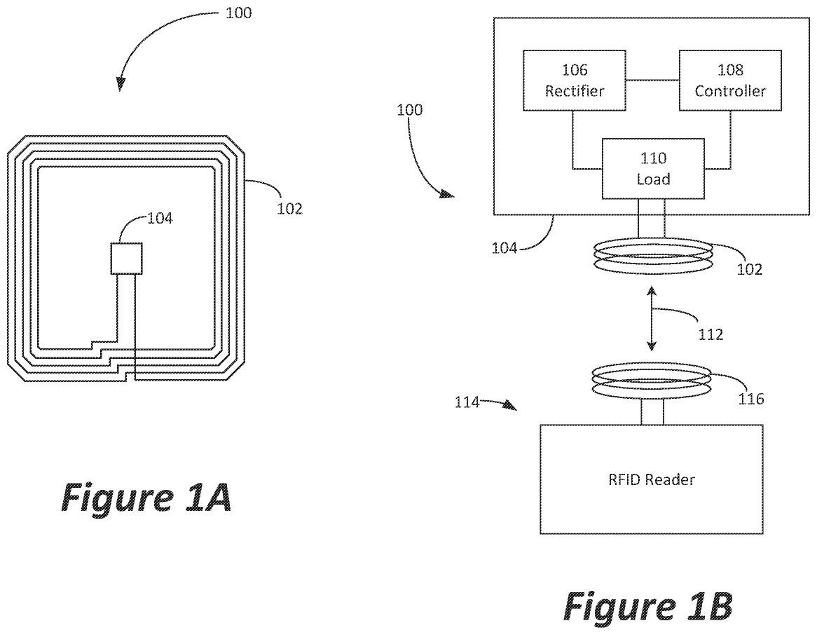

RF monitoring and tracking systems are known in the art. One example is radio frequency identification (RFID) technology. FIGS. 1A and 1B illustrate an example of an RFID tag 100, as is commonly attached to an asset. The RFID tag comprises an antenna 102 and a microchip 104. The microchip comprises circuitry including rectifier circuitry 106, control circuitry 108, and load circuitry 110. The RFID tag rectifies RF energy 112 received via the antenna and uses the energy to power the operation of the RFID tag. In the illustrated example, the RF energy is transmitted from an RFID reader 114 via the RFID reader's antenna 116. The activated RFID tag may be configured to modulate the load circuitry 110 to transmit information back to the reader. The information may comprise a string of data, such as an identification number.

RFID tags are commonly used for many applications, such as tracking tools, equipment, inventory, assets, people, or other objects. But their use is limited by several factors. One limitation is that the amount of power that can be harnessed when activated by the RFID reader is typically not sufficient to power the operation of sensors, such as accelerometers, and the other types of sensors mentioned above. Accordingly, their functionality is typically limited to providing ID information or other simple strings of data. Also, the transmission distance is limited to about 20-50 feet. Adding a battery to an RFID-based tag can increase its functionality and transmission range. But in a highly distributed environment with many sensors, maintaining and replacing batteries in battery-powered sensors may become cumbersome.

Aspects of this disclosure RF-based sensors and sensor packages that can be distributed throughout an environment and that include a self-contained power supply, such as a capacitor (e.g., a super-capacitor) or a rechargeable battery. Embodiments of the disclosed sensor packages are configured to harvest RF energy from the atmosphere to charge the power supply.

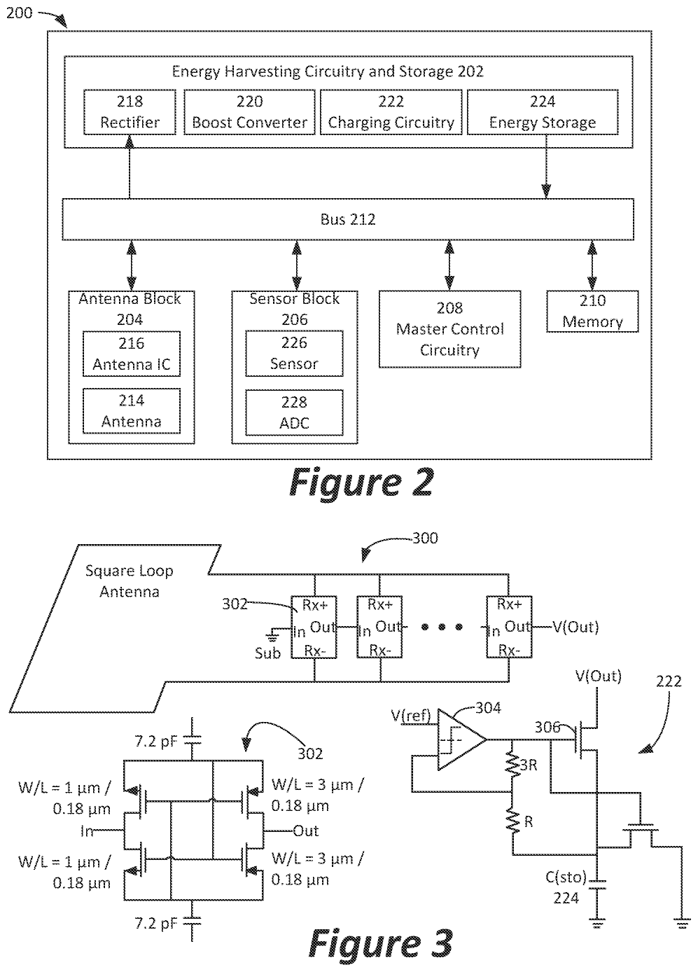

FIG. 2 shows a schematic of a sensor package 200 according to aspects of the disclosure. The illustrated sensor package 200 comprises an energy harvesting circuitry and storage section 202, an antenna block 204, a sensor block 206, a master control circuitry 208, and a memory/storage section 210, each of which is connected to a bus 212. It should be noted here that each of the illustrated sections are only meant to be logical sections for an understanding of the sensor package. The sensor package 200 may be implemented using architectures and layouts that are significantly different than the one illustrated. For example, multiple sections may be implemented on a single chip and/or some of the sections that are discrete in the illustration may be implemented across multiple chips/circuits. Likewise, the illustrated bus 212 is configured to carry both data and power, but those functionalities may be implemented as separate busses or paths and multiple busses and paths may be implemented to carry data and/or power.

The antenna control section 204 of the illustrated sensor package 200 comprises an antenna 214. The antenna 214 can generally be any type of antenna known in the art that is preferably optimized to receive and transmit RF radiation in the relevant frequency band(s). Example embodiments described herein operate in the 915 MHz band (902-928 MHZ) and/or the 2.4 GHz band (e.g., 2.4-2.5 GHZ) band, though any RF energy may be used, depending on the environment. For example, the antenna may be a square loop antenna, a coil or helical antenna, or any other antenna configuration known in the art.

The antenna control section may also comprise an antenna integrated circuit (IC) 216. It should be noted that some or all of the functionality of the antenna IC 216 described here may alternatively be performed by aspects of the sensor control section 206 and/or the master control circuitry 208, each of which are described below. The antenna IC may comprise a microcontroller, microprocessor, an analog-digital/digital-analog (AD/DA) converter, power management circuitry, clocking circuitry, and the like. The antenna IC is configured to receive RF power and provide the power to the bus 212. The antenna IC is also configured to provide data carried by the received RF signal to the bus and to cause the antenna to transmit data received from the bus. Data transmission may be via backscatter transmission, for example. The antenna IC may be configured to associate a unique identifier tag with the transmitted data. An example of an antenna IC is the SL900A, manufactured by AMS Osram (Premstätten, Austria).

The RF power received by the antenna is rectified by a rectifier 218. Generally, any rectification configuration may be used. According to some embodiments, the rectifier is a high efficiency cross-coupled differential RF rectifier and may be based on CMOS technology. FIG. 3 illustrates an example of a cross-coupled rectifier 300 configured to rectify energy received from a square loop antenna 214. The antenna 300 comprises a plurality of rectifier stages 302. An example of one of the rectifier stages 302 is also illustrated. Note that the values for the capacitors and transistors in the illustration are examples only. According to some embodiments the rectifier circuitry may be configured to require minimum incident power on the order of 6.2 μW (−22 dBm).

Referring again to FIG. 2, according to some embodiments, boost converter circuitry 220 may be used to boost the rectifier voltage V(out) to a suitable voltage for charging the energy storage 224. Boost converter circuitry is well known in the art and is not described here in detail. The rectified voltage from the rectifier 218 (and, optionally boosted by the intervening boost converter circuitry 220) is provided to charging circuitry 222, which is configured to charge the energy storage 224. FIG. 3 illustrates an embodiment of charging circuitry 222, whereby the rectified voltage V(out) is used to charge the energy storage 224 (a capacitor C(stor)) in the illustration). A comparator 302 is used to compare the charge on the charge storage 224 and to open a switch 306 when an appropriate voltage is obtained on the energy storage 224. It should be noted that the energy storage may generally be any appropriate energy storage technology, for example, a Li-ion battery, a thin film battery, a supercapacitor, or a conventional capacitor. One particular embodiment of an energy storage 224 is an electric double-layer capacitor (EDLC). The energy stored in the energy storage 224 can be made available to the other components of the sensor package 200 (for example, via the bus 212).

The sensor package 200 may comprise one or more sensor blocks 206. Each sensor block may comprise one or more sensors 226. One example of a sensor 226 is an accelerometer. The accelerometer may generally be any type of accelerometer known in the art. One embodiment of an accelerometer may be based on microelectromechanical systems (MEMS) technology. The accelerometer may be a single plane axis or a 3-axis accelerometer, for example. One example of a suitable accelerometer according to some embodiments is based on the ADXL1000/ADXL1002 single plane axis accelerometer from Analog Devices, Inc. (Wilmington, MA, USA). Another example of a suitable accelerometer according to some embodiments is based on the ADcmXL3021 3-axis accelerometer, also from Analog Devices, Inc. The sensor block may also comprise an analog/digital converter (ADC) 228, as well as other supporting circuitry, such as further power management, embedded processing, and bus interface(s). The sensor block may be powered by 3.3 V DC, supplied from the bus 212, according to some embodiments. Other sensors/sensor blocks may additionally (or alternatively) be contained within the sensor package 200. Examples of other sensors include sensors for pressure, temperature, flow, acoustics, ultra-sonics, chemical analysis, pH, and the like. For example, a temperature sensor may be any type of temperature sensor, such as a thermocouple, RTD, thermistor, IR sensor, etc. Likewise, a pressure sensor may be any type of pressure sensor, such as piezoelectric device, strain gauge, etc.

Referring again to FIG. 2, data from the one or more sensor blocks 206 may be provided via the bus 212 to the master control circuitry 208. The master control circuitry 208 may control the transmission of the sensor data from the sensor package via the supporting circuitry and the antenna of the antenna block 204. According to some embodiments, the control circuitry may be configured to process and/or analyze the sensor data and to send alerts or other information based on the sensor data from the sensor package. Examples of analysis based on the sensor data are discussed in more detail below. According to some embodiments, the control circuitry may be configured to monitor and/or control the operation and/or state of the sensor package itself.

The sensor package may also comprise a memory 210. The memory may be configured to store sensor data and/or processed sensor data. The memory may also be configured to store algorithms and/or instructions, for example, for the processing of sensor data and/or for the operation of the sensor package. Memory for the storage of data may be read/writable. Memory for the storage of algorithms may, in some embodiments, be non-transitory.

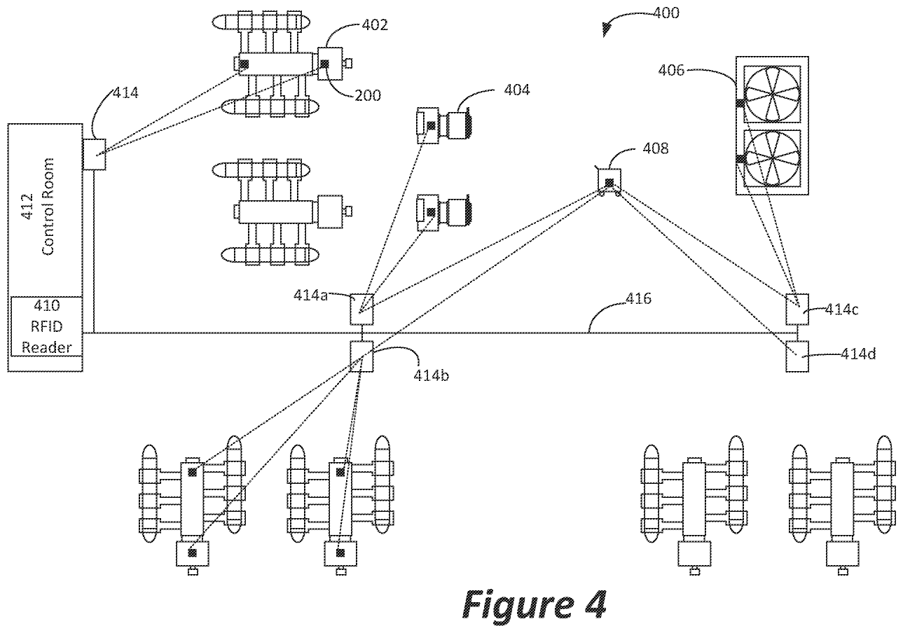

FIG. 4 illustrates an example of an environment 400 in which a monitoring system using the disclosed sensor packages may be employed. The illustrated environment is a plant, such as a gas processing plant. But as mentioned above, the disclosed sensor packages may be employed in a wide range of different environments. The illustrated environment includes a plurality of assets, including immobile assets, such as reciprocating compressors 402, centrifugal compressors 404, a cooling tower 406, and a mobile asset 408. In the plant environment, the mobile asset may be gas cylinders, a welding cart, an air purifier, or the like. In a hospital environment, the mobile asset may be a crash cart, an IV pump, a patient bed, etc. Likewise, in a hospital environment the immobile assets may be diagnostic equipment, etc. The “assets” may also include people, such as personnel, patients, etc. The environment 400 may comprise one or more RFID readers 410. The RFID reader 410 is located in a control room 412 in the illustrated example, but other configurations are possible. In the illustrated example, the RFID reader 410 is connected to a plurality of RF antennas 414 (referred to herein as remote antennas since they are remote from the sensor packages) via cables 416. The remote RF antennas are configured to communicate with the sensor package(s) 200 (represented by the solid squares) associated with the assets. Note that only a few of the sensor packages are shown in the illustration, for the sake of clarity.

According to some embodiments, the remote RF antennas 414 may be configured to continuously broadcast RF radiation, which the sensor packages may harvest and use to maintain the charge of the energy storage of the sensor packages. Alternatively, the remote antennas may periodically broadcast the RF radiation. Likewise, the sensor packages may continuously transmit their data, they may periodically transmit their data, and/or they may transmit data when the RFID reader poles them to do so. According to some embodiments, the system may use multiple bands of radiation. For example, the system may broadcast one band of RF radiation that is used for energy harvesting and another band (e.g., a second band) of radiation that is used to interrogate the sensor package(s). In such an embodiment, the sensor package(s) may transmit their data back to the remote RF antennas on the second band. Some system embodiments may use a first remote RF antenna configuration to broadcast the powering RF energy and a second RF antenna configuration to communicate with the sensor packages.

According to some embodiments, the sensor packages may be configured to use background or “native” RF radiation for energy harvesting. For example, a significant amount of background RF radiation may be present in a plant environment containing reciprocating and/or rotational equipment (e.g. motors and/or generators), and the sensor packages may be configured to use that radiation for charging the energy storage. In such an embodiment, it may not be necessary to broadcast further RF radiation for energy harvesting. Likewise, in an office or medical facility, a significant amount of radiation may be present because of WiFi communications, etc. (e.g., 2.4 GHz, 5 GHZ, etc.) which may be used for energy harvesting.

According to some embodiments, the sensor package(s) may transmit raw sensor data to the RFID reader via the remote RF antenna(s) 414. In such an embodiment, backend computing resources (for example, in the control room 412) may process the data. According to other embodiments, some, or all of the processing of the sensor data may be performed within the sensor package(s), which may then transmit the results, alerts, status updates, etc., to the RFID reader. According to some embodiments, data (i.e. vibration waveforms) may be too large to transmit cither due to antenna IC capacity or transmission bandwidth limitations and may need to be parsed in a structure or “packets” and compiled on the receiving side to create a complete measurement file. In some embodiments, the data and/or the signal from the sensor package may be encrypted, modulated, or otherwise processed. According to some embodiment, the sensor package(s) may be configured to sense and transmit data (raw or processed) continually for continual monitoring. According to other embodiments, the sensor package(s) may be configured to sense and transmit data periodically or when prompted to do so. The sensor package(s) may be clocked using their own internal clock or may be clocked by signals received from another device. According to some embodiments, the sensor package(s) may be triggered to measure and/or transmit information based on signals received from other sensors, such as proximity sensors, rotation sensors, temperature sensors, pressure sensors, and the like. In some embodiments the data measured by the sensor package(s) may be synched with the triggering data from the external sensor(s), as is the case in the example of the vibrational sensor described below.

According to some embodiments, the system may be configured to determine/track a location of an asset, such as a moveable asset. Notice in FIG. 4 that the sensor package of the moveable asset 408 is configured to communicate with four of the remote RF antennas (i.e., 414a-414d). The relative strength of the radiation that each of those remote antennas receive from the asset's sensor package may vary depending on the asset's location. Triangulation methods may therefore be used to track the asset's location within the environment. Triangulation methods are well known in the art and will not be discussed here. According to some embodiments, sensor packages that are used for tracking/location only may or may not include additional sensors (such as an accelerometer or the like).

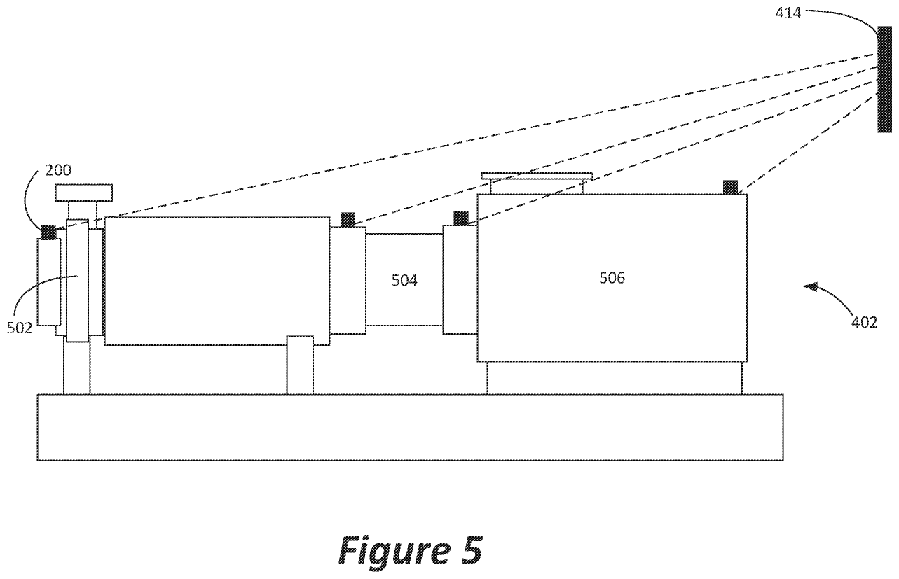

FIG. 5 illustrates a typical centrifugal pump 402 having sensor packages 200 configured at the impeller 502, the bearings 504, and the motor 506. In the illustrated example the sensor packages may comprise a triaxial accelerometer as the sensor. Other deployment configurations may be used, for example, if the accelerometers are single axis. The sensor packages are configured to receive RF radiation from a remote antenna 414 and to transmit their data to the remote antenna. As mentioned above, processing resources within the sensor packages 200 may be configured to process the accelerometer data and to send alerts or status updates to the remote antenna 414. Alternatively, the sensor packages may transmit raw accelerometer data to the remote antenna and backend processing may be used to process the accelerometer data.

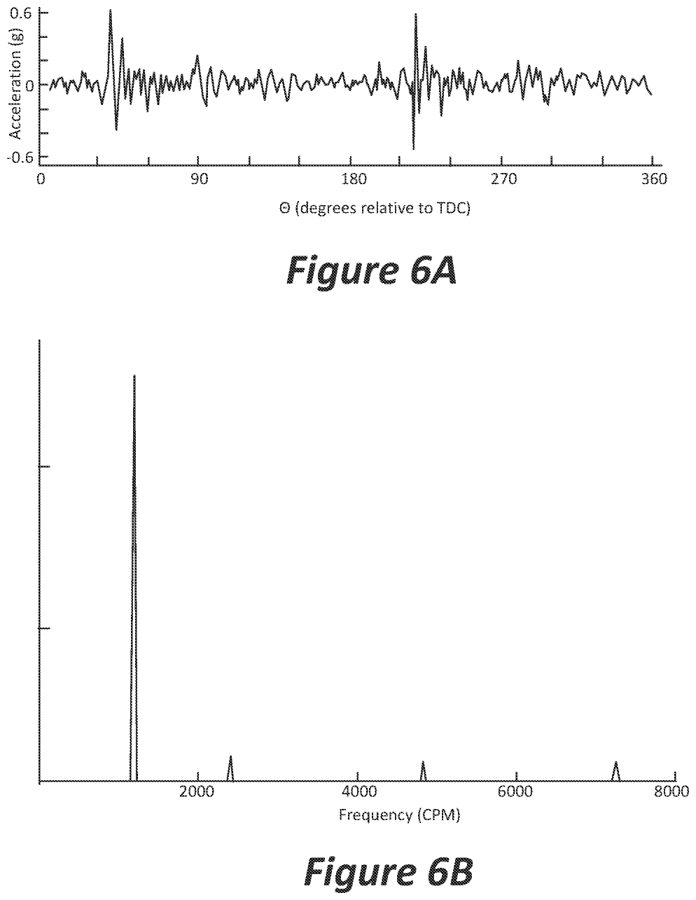

FIGS. 6A and 6B illustrate examples of accelerometer data that may be collected using the sensor packages 200. FIG. 6A illustrates acceleration measured for a reciprocating pump crosshead as a function of rotation angle. In this example, the vibrational sensor of the sensor package may be triggered by, and synched with, rotational data measured using rotation sensor associated with the pump. The rotational sensor may comprise a proximity detector, for example, and may be configured to sense the position of one or more of the pump components with respect to their positions at top dead center (TDC). According to some embodiments, the rotation sensor may itself be an RF-harvesting sensor package as described herein. Vibrations at certain angles of the cycle may be indicative of wear or particular failure modes. According to some embodiments, algorithms within the sensor packages or within the backend processing may be configured with thresholds respective to such vibration modes and may be configured to issue alerts should they occur. Other embodiments include weighted threshold(s) and/or impact counting. FIG. 6B illustrates fast Fourier transform (FFT) analysis of accelerometer data. Again, certain peak frequencies may be indicative of particular wear and/or failure modes. The sensor packages and/or the backend processing may be configured to perform the FFT and to monitor for such frequencies. It should be noted that accelerometers may be used to monitor vibrations in other equipment, such as pressure vessels, pipes, and the like. In some embodiments of the system, some memory may be omitted and may only rely on the memory contained within the antenna IC. In such embodiments, the controller may be used to write Data to the antenna IC registers. That controller would then regulate the population of Data on the antenna IC as it is updated (transmitted/ready for transmission), acting as a Data flow controller. In this same “lite” version, smaller power storage device(s) may be incorporated as it would only energize the controller and not assist in the Data transmission. The antenna IC would solely be energized by the interrogating antenna (passive architecture). According to some embodiments, such as a passive transmission design, much of the circuitry may be scaled down or omitted, including the charge capacitors, boost converter, storage capacitor(s) and/battery, memory, etc., resulting in a lower cost device. According to some embodiments, transmission circuitry powered by the electrical energy captured by the antenna and configured to cause the antenna to transmit (via backscatter) signal(s) comprising data indicative of the sensed condition/operating parameter as present or updated on the antenna IC.

Although particular embodiments of the present invention have been shown and described, it should be understood that the above discussion is not intended to limit the present invention to these embodiments. It will be obvious to those skilled in the art that various changes and modifications may be made without departing from the spirit and scope of the present invention. Thus, the present invention is intended to cover alternatives, modifications, and equivalents that may fall within the spirit and scope of the present invention as defined by the claims.

What is claimed is:

1. A monitoring system for monitoring assets in an environment, the system comprising:
at least one sensor package configured to couple to an asset, each of the sensor packages comprising:
an antenna configured to receive radio frequency (RF) energy,
rectifier circuitry configured to convert a portion of the RF energy to electrical energy,
at least one sensor powered by the electrical energy and configured to sense a condition of the asset, and
transmission circuitry powered by the electrical energy and configured to cause the antenna to transmit one or more signals comprising data indicative of the sensed condition.

2. The system of claim 1, wherein the sensor package further comprises a power storage and circuitry configured to charge the power storage using the electrical energy.

3. The system of claim 2, wherein the power storage is a battery, a supercapacitor, or a capacitor.

4. The system of claim 1, wherein the asset is a pump, engine, motor, compressor, or fan.

5. The system of claim 1, wherein the sensor comprises an accelerometer, a temperature sensor, a flow meter, ultrasonic, or a pressure sensor.

6. The method of claim 5, wherein the condition is vibration, acceleration, temperature, flow rate or pressure.

7. The system of claim 5, wherein the sensor comprises an accelerometer configured to sense vibration of a portion of the asset to determine vibration data.

8. The system of claim 7, wherein the sensor package further comprises control circuitry configured to process the vibration data.

9. The system of claim 8, wherein the control circuitry is further configured to use the vibration data to determine an indicium of health of the asset.

10. The system of claim 8, wherein the processing comprises performing a fast Fourier transform (FFT) of the vibration data.

11. The system of claim 1, wherein the transmission circuitry is configured to associate an identifier indicative of the sensor with the transmitted one or more signals.

12. The system of claim 1, wherein the RF energy has a frequency of 902 to 928 MHz.

13. The system of claim 1, wherein the RF energy has a frequency of 2.4-2.5 GHZ.

14. The system of claim 1, wherein the RF energy is ambient RF energy generated by one or more motors.

15. The system of claim 1, further comprising one or more remote antennas configured to broadcast the RF energy throughout at least a portion of the environment.

16. The system of claim 15, wherein the one or more transponders are configured to receive the one or more signals.

17. The system of claim 16, further comprising a processor configured to receive the one or more signals from the remote antenna and to use the signals to determine an indicium of health of the asset.

18. The system of claim 17, wherein the condition is vibration, proximity, temperature, pressure, flow, and or location.

19. The system of claim 1, wherein the at least one sensor package is configured to be triggered based on one or more signals received from one or more second sensors.

20. The system of claim 19, wherein the second sensors comprise a rotation sensor.
